(19) United States
(12) Patent Application Publication
(10) Pub. No.: US 2024/0091853 A1
(43) Pub. Date: Mar. 21, 2024

(54) CERAMIC SCINTILLATING MATERIALS AND METHODS OF FABRICATION THEREOF

(71) Applicant: Purdue Research Foundation, West Lafayette, IN (US)

(72) Inventors: Yi Xie, West Lafayette, IN (US); Logan Joyce, West Lafayette, IN (US)

(73) Assignee: Purdue Research Foundation, West Lafayette, IN (US)

(21) Appl. No.: 18/369,383

(22) Filed: Sep. 18, 2023

Related U.S. Application Data
(60) Provisional application No. 63/407,926, filed on Sep. 19, 2022.

(51) Int. Cl. B22F 3/16; B22F 1/142; B22F 9/04

(52) U.S. Cl. CPC B22F 3/16; B22F 1/142; B22F 9/04; B22F 2009/043; B22F 2302/253; B22F 2998/10

(57) ABSTRACT

A method of fabricating a material is described. The method includes preparing a powder mixture including yttrium aluminum garnet doped with a fissionable isotope, grinding the powder mixture to form a first milled powder, drying the first milled powder, calcinating the first milled powder to form a calcinated powder, grinding the calcinated powder to form a second milled powder, drying the second milled powder, shaping the second milled powder to form a plurality of shaped material portions, and sintering the plurality of shaped material portions.

### CROSS-REFERENCE TO RELATED APPLICATIONS

This application is related to and claims the priority benefit of U.S. Provisional Patent Application No. 63/407,926, entitled “Neutron Pulse Pumped Laser Material,” filed Sep. 19, 2022, the contents of which are hereby incorporated by reference in their entirety into the present disclosure.

### TECHNICAL FIELD

The present application relates to materials suitable for neutron flux monitoring, and specifically to systems and methods for fabricating transparent-ceramic materials that emit light when interacting with neutron and ionizing radiations.

### BACKGROUND

This section introduces aspects that may help facilitate a better understanding of the disclosure. Accordingly, these statements are to be read in this light and are not to be understood as admissions about what is or is not prior art.

Measuring neutron flux over time in nuclear experiment reactors, especially transient reactors, presents a difficult challenge. Similarly, the emergence of autonomous small or micro reactor systems will require accurate active power measurement. Neutron flux sensors thus play an important role for these nuclear reactor systems, as well as in other similar environments and applications.

Neutron flux sensors often include transparent-ceramic scintillator materials due to their mechanical durability, resilience, and efficiency when deployed in harsh environments such as within nuclear reactors. A transparent-ceramic scintillator material is a type of crystalline substance that can emit light (scintillation) when it interacts with ionizing radiation such as gamma rays, X-rays, or charged particles like electrons. These scintillators are used in various applications, including radiation detection and imaging systems. Transparent-ceramic scintillators have advantages over traditional single-crystal scintillators, such as improved mechanical properties and ease of fabrication. One common example of a transparent-ceramic scintillator material is cerium-doped lutetium aluminum garnet (LuAG:Ce), which is known for its high light output and fast response time. Other transparent-ceramic scintillators may use different host crystals and activator ions to tailor their scintillation properties for specific purposes. Transparent-ceramic scintillators offer a balance between performance and durability, making them valuable components in a wide range of radiation detection and imaging systems. Their ability to withstand demanding conditions and provide accurate radiation detection makes them crucial in various fields of science, medicine, and industry.

Neutron flux sensor instrumentation needs to be small due to some compact reactor core sizes, and they also must be robust and durable for operation within these extreme environments. Existing neutron flux sensors do not meet these requirements. Moreover, while some types of existing scintillator materials have different compositions, none of the existing materials can adequately measure thermal and fast neutron flux. Instead, sensors formed of existing materials often only measure X-ray and gamma rays. Thus, improved materials are needed which could, in some applications, be utilized to form improved neutron flux sensors and similar devices. Improved transparent-ceramic scintillating materials, and the fabrication thereof, are therefore presented herein.

### SUMMARY

Aspects of this disclosure describe methods of fabricating various transparent ceramic materials. In some embodiments, the method can include one or more steps such as preparing a powder mixture including yttrium aluminum garnet doped with a fissionable isotope, grinding the powder mixture to form a first milled powder, drying the first milled powder, calcinating the first milled powder to form a calcinated powder, grinding the calcinated powder to form a second milled powder, drying the second milled powder, shaping the second milled powder to form a plurality of shaped material portions, or sintering the plurality of shaped material portions. In some embodiments, the fissionable isotope can include a uranium isotope, and the powder mixture can include solid yttria (Y₂O₃) powder, alumina (Al₂O₃) powder, and the fissionable isotope in stoichiometric ratios. There are various methods for preparing the powder mixture, with one such method including solid-state reaction (SSR) powder formation method.

Various alternative embodiments of the method are presented. For example, in certain embodiments, one or more of the following aspects may be included: either instance of grinding the powders can include a ball milling process, the first milled powder can be strained prior to drying the first milled powder, or drying the first milled powder can include additional steps such as placing the first milled powder into a furnace and heating the first milled powder in the furnace at 110° C. for 24 hours. In still additional aspects, calcinating the first milled powder can include heating the first milled powder from approximately room temperature to above 1000° C., holding the first milled powder at a dwell temperature above 1000° C. for a dwell time period, and cooling from the dwell temperature to approximately room temperature. The dwell time period can be greater than five hours. Further, shaping the second milled powder can include activating a hydraulic press to form one or more of cylinders or pellets of the second milled powder, and sintering can include activating an alumina tube furnace or a tungsten mesh vacuum furnace.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic view of light scattering while traveling through an isotropic polycrystalline ceramic;

FIG. 2A depicts a data table showing selected optical properties of YAG;

FIG. 2B depicts a data table showing selected thermal properties of YAG;

FIG. 2C depicts a data table showing selected physical properties of YAG;

FIG. 2D depicts a data table showing selected mechanical properties of YAG;

FIG. 3 depicts a phase diagram for an example Y—Al—O system;

FIG. 4 depicts a schematic diagram of one unit cell of YAG;

FIG. 5 depicts graphical diagrams showing relative XRD reference patterns of YAG, YAP, YAM, B₂O₃, SiO₂, Y₂O₃, and Al₂O₃;

FIG. 6 depicts a flowchart showing common fabrication methods including co-precipitation and solid-state reaction (SSR);

FIG. 7A depicts a schematic view of particle packing prior to sintering, showing X as the distance between the center of the particles which is reduced as sintering occurs;

FIG. 7B depicts a schematic view of the particle of FIG. 7A after partial sintering, showing a reduction in pore size;

FIG. 8 depicts a plot diagram of the change in transmittance of Yb:YAG sintered at 1750° C. for 15 hours as a result of ball milling time, with the square points representing the approximate particle size, the circles representing 600-nm wavelength, and the triangles representing 1100-nm wavelength;

FIG. 9 depicts a graphical representation of the effect of powder crystallinity on transmittance of Nd:YAG samples sintered at 1780° C. for 10 hours;

FIG. 10 depicts graphical diagrams showing relative XRD results of powders calcinated at various temperatures;

FIG. 11A depicts an SEM image of a grain structure of a sintered sample calcinated at 900° C.;

FIG. 11B depicts an SEM image of a grain structure of a sintered sample calcinated at 1000° C.;

FIG. 11C depicts an SEM image of a grain structure of a sintered sample calcinated at 1100° C.;

FIG. 11D depicts an SEM image of a grain structure of a sintered sample calcinated at 1200° C.;

FIG. 11E depicts an SEM image of a grain structure of a sintered sample calcinated at 1300° C.;

FIG. 11F depicts an in-line transmittance graphical plot of the sample shown in FIG. 10E;

FIG. 12 depicts a schematic view showing an illustration of different packing structures within a green body ceramic as a result of powder morphology;

FIG. 13A depicts a schematic view of a dry-pressing consolidation method for producing ceramic green bodies;

FIG. 13B depicts a schematic view of a slip casting consolidation method for producing ceramic green bodies;

FIG. 13C depicts a schematic view of a viscous plastic processing consolidation method for producing ceramic green bodies;

FIG. 13D depicts a schematic view of a gelcasting consolidation method for producing ceramic green bodies;

FIG. 13E depicts a schematic view of an injection moulding consolidation method for producing ceramic green bodies;

FIG. 13F depicts a schematic view of a freeze casting consolidation method for producing ceramic green bodies;

FIG. 14 depicts an in-line transmittance graphical plot of polycrystalline 1 at. % Nd:YAG samples with the same sintering aids of SiO₂ and B₂O₃ in flowing O₂ compared to vacuum atmosphere;

FIG. 15 depicts a graphical plot showing the relative density of polycrystalline YAG sintered in vacuum relative to air at given temperatures;

FIG. 16 depicts a graphical plot showing grain size increases with the increase of SiO₂ concentration at given temperatures;

FIG. 17A depicts a pair of SEM images of mirror polished (top) and fractured (bottom) polycrystalline YAG with sintering aids of 0.14 wt. % SiO₂;

FIG. 17B depicts a pair of SEM images of mirror polished (top) and fractured (bottom) polycrystalline YAG with sintering aids of 0.145 wt. % SiO_{2+0.10} wt. % MgO;

FIG. 17C depicts a pair of SEM images of mirror polished (top) and fractured (bottom) polycrystalline YAG with sintering aids of 0.10 wt. % MgO; and

FIG. 18 depicts one exemplary method of fabricating a ceramic scintillating material.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

I. Overview

Fission energy produced from fissionable (e.g., U-238) and fissile (e.g., U-235) isotopes is suspected to provide sufficient energy to cause luminescence in a host material. The intensity of luminescence may be correlated to the neutron flux, therefore providing a method of measuring neutron flux with a rapid response time. Yttrium aluminum garnet (YAG) is one such host material that can accommodate the fissionable and fissile isotopes into its crystal lattice. YAG has been used widely as a gain material for solid-state lasers in the form of neodymium (Nd) doped YAG (Nd:YAG) as well as a scintillator in the form of cerium (Ce) doped YAG (Ce:YAG). The Nd:YAG crystals are used in medicine, dentistry, manufacturing, and defense. The Ce:YAG crystals are used as a highly effective gamma-ray scintillator. The quantum properties of YAG allow light emission of specific wavelengths when energy is provided to the material. The high thermal stability, chemical stability, and mechanical strength of YAG, make the material an ideal candidate for neutron flux sensor in extreme environments. Therefore, fissionable or fissile isotope doped YAG, described herein as U:YAG, is an improved scintillator material which can measure neutron flux over time in extreme environments.

The YAG or doped YAG has been successfully fabricated in both single crystal and polycrystalline forms. Single crystal is generally made by the crystal growth method, which takes weeks to months to grow and the allowable concentration of dopant in the crystal is limited. However, a higher concentration of dopant is desirable as it extends the scintillator's life. Conversely to the crystal growth method, the synthesis and processing method can make transparent polycrystalline YAG or doped YAG in a short period of time and allow a higher concentration of dopant. Transparent polycrystalline exhibits the same light transmittance as single crystal, and thus has many advantages over single crystal, including reduced production cost and time. Moreover, a higher concentration of dopant can be added to the polycrystalline form relative to the single crystalline form.

Fabrication of transparent polycrystalline U:YAG supports the development of advanced neutron flux sensors; however, fabrication methods are complex and relatively unexplored. In one fabrication of U:YAG powder, a co-precipitation method was used. Another fabrication method involved sintering transparent U:YAG using co-precipitation and vacuum sintering methods. Another fabrication method involved sintering transparent U:YAG using solid-state reaction (SSR) and vacuum sintering methods.

The improved fabrication of transparent polycrystalline U:YAG as described herein is a complex process. Microstructure and light transmittance properties are affected by each processing step, from powder synthesis to sintering. Each of these steps has multiple parameters which can be optimized, or in some cases must be optimized. To find the optimal processing parameters for U:YAG, the techniques and methods that have been used to fabricate transparent polycrystalline Nd:YAG, Ce:YAG and others, are described herein with a focus of analyzing the difference in results obtained by method variations, and suggesting the appropriate methods and parameters to fabricate transparent polycrystalline U:YAG. The review provides helpful insights on the fabrication of transparent polycrystalline U:YAG and accelerates the development of advanced neutron flux sensors and the like.

II. Transparent Ceramics vs. Single Crystals

Single crystals are formed through crystal growth processes which can require extended periods at high temperatures. Crystal growth has numerous difficulties associated with the process, including high temperature, slow growth rates, non-uniform composition, brittle products, and extensive optimization of growth parameters. Sintering powders to form solid structures is a well-established technology that has been employed for thousands of years to fabricate various ceramic materials. However, the ability to sinter ceramics to a sufficient density for light transmittance is relatively new. When highly optimized, the polycrystalline synthesis method has many advantages over the crystal growth process, primarily, reduced time and cost, increased mechanical strength, production scalability, and complex shape formation. As an example, the traditional method for producing single crystalline Nd:YAG material uses the Czochralski crystal growth process. Fabrication of the single crystal Nd:YAG requires about one month (the growth rate of Nd:YAG is approximately 0.2-0.5 mm/h) at a temperature of 1970° C. Due to the difference in ionic radius of Nd compared to Y, the segregation coefficient of Nd in YAG is approximately 0.2. This restricts the maximum concentration of Nd that can be doped into YAG single crystal to approximately 1-1.5 at. %. An additional complication of the Czochralski crystal growth process is the extensive post-processing as the grown crystal has an amorphous shape.

In comparison, transparent polycrystalline YAG ceramics can be produced in a few days with increased dopant concentration and in controlled geometries. The procedure follows three general steps: powder preparation, green body formation, and sintering. The exact parameters of the sintering procedure are highly dependent on the powder preparation and sintering method. In general, the sintering profile for YAG with sintering aids in a vacuum furnace requires a temperature of around 1750° C. for about eight hours to achieve transparency. Other sintering methods, such as spark plasma sintering (SPS), hot isostatic press (HIP), and two-step sintering (TSS), can often reduce the sintering time required. As mentioned before, higher dopants can be achieved by the sintering method than crystal growth method because a solid-liquid interface which promotes segregation is not present during the process. A dopant concentration of 9 at. % in the Nd:YAG still remains transparent. This concentration is significantly higher than the ˜1 at. % maximum of crystal growth method.

Producing transparent polycrystalline ceramics is also challenging because the elimination of defects is important to prevent light scattering. A theoretical model for the scattering of light in translucent alumina (Al₂O₃) provides a framework to understand the impact of defects on transparency. The transmission of light through a material is affected by four key phenomena: intrinsic scattering between grain boundaries (birefringence), surface scattering from nonuniform surfaces, scattering due to pores in microstructure, and light absorption due to secondary phases. The intrinsic scattering of the sample can be mitigated by selecting a material that has an optically isotropic crystalline structure. A cubic lattice does not experience light scattering due to birefringence because the crystallographic orientation of grains does not affect the index of refraction. Surface effects can severely reduce transmittance as the incoming light is scattered prior to entering the material. This effect can be eliminated by polishing the material to a high degree. Secondary phases contained in the microstructure can result in scattering or absorption. These phases can form due to contamination, improper stochiometric ratios, and additives. The use of additives is of high importance during fabrication as they can often aid in eliminating pores, preventing grain growth, and reducing sintering temperature or holding time. However, only small quantities are permitted, to prevent secondary phase formation. Other sources of secondary phases may be prevented through careful experimental procedures. Finally, the most significant source of light scattering in a high-purity sample is the presence of pores in the microstructure. Because of the difference in the refractive index between ceramic materials and the gas-filled pores, they are highly effective at scattering light. For polycrystalline alumina, a porosity (one minus relative density) of 0.1% decreases the real in-line transmission (RIT) from 86% to 1% when the pore diameter is similar to the wavelength of the light. Therefore, to obtain transparent polycrystalline ceramics, the elimination of pores is desirable.

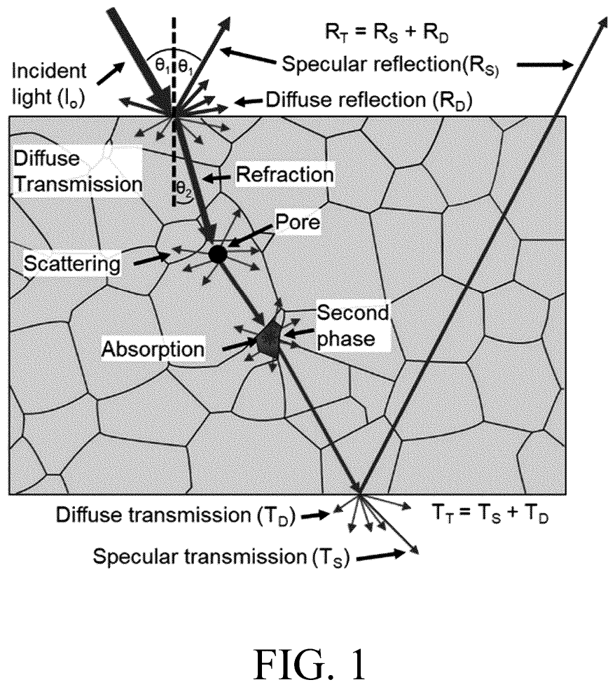

The four conditions which affect light transmittance are shown in FIG. 1. In FIG. 1, the red line indicates the light traveling through the material and the line thickness corresponds to the total amount of light that is able to be transmitted. At the surface, light is scattered due to the change in the index of refraction and the nonuniform surface. The light then encounters a pore which results in significant scattering due to the multiple changes in the index of refraction. Next, a secondary phase is encountered, which may either scatter or absorb the light. Finally, only a small amount of the initial light passes through the material because of the defects which are encountered. This diagram does not show the effects of birefringence. If this were shown, the light would refract each time a grain boundary is crossed.

III. YAG Properties and Crystal Structure

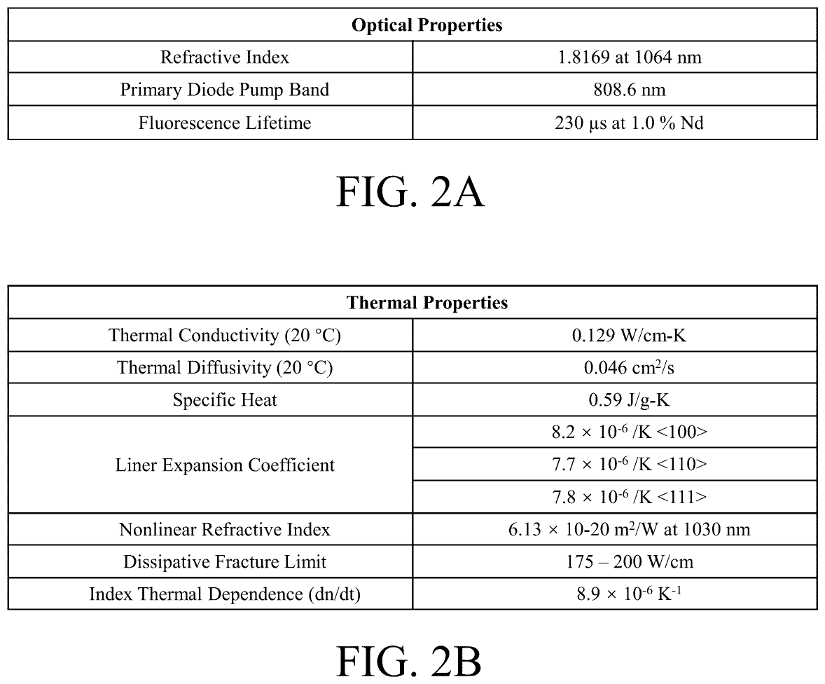

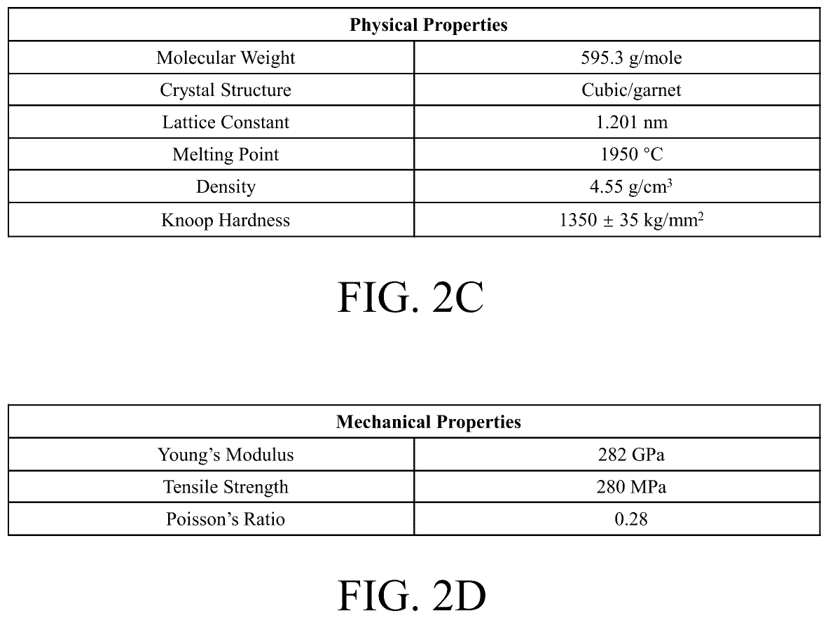

YAG is a well-established gain material for solid-state lasers as it can be doped with a variety of fluorescent elements. The wide variation in atomic substitution allows for fine control over the wavelength of the laser. The material is selected as an excellent laser host due to its high efficiency attainable due to the mechanical strength, thermal conductivity, and chemical stability. A selection of the thermal, optical, physical, and mechanical properties is listed in the tables of FIGS. 2A-2D.

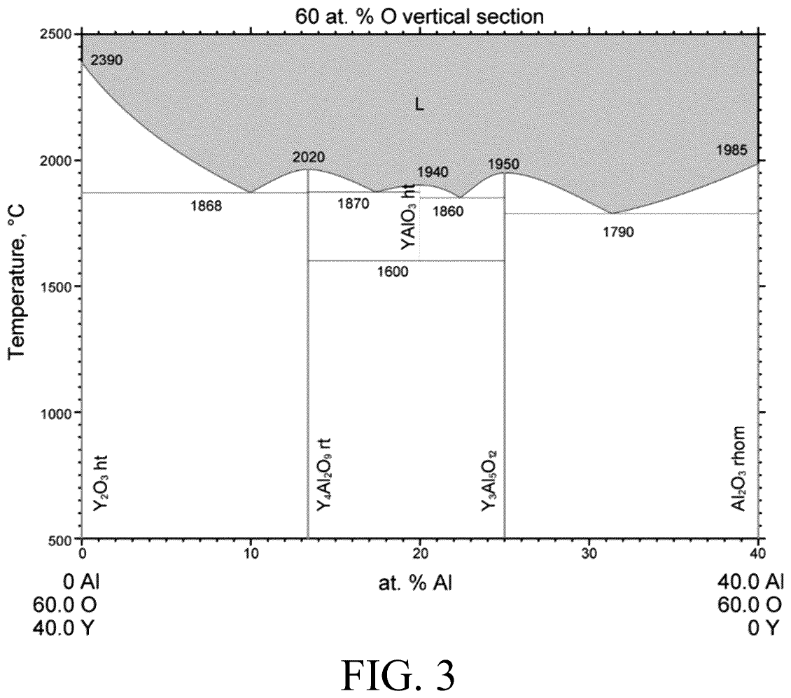

The YAG phase is a stochiometric line in the phase diagram of Y—Al—O, as shown in FIG. 3. The garnet phase is labeled as YAG, at which the ratio of Al:Y is 5:3. There are three ternary compounds in the system: YAG, YAP (YAlO₃), and YAM (Y₄Al₂O₃). The two phases, YAP and YAM, may be created as intermediate phases. The exact variation in stoichiometry that would still produce the YAG phase was previously determined. For an excess of 1.0 at. % yttria, secondary phases cannot be detected by x-ray diffraction (XRD), so transparent samples can still be sintered. However, the presence of any excess Al₂O₃ is detrimental to transparency despite no evidence of a secondary phase being found through XRD analysis. The amount of excess Al₂O₃ that could be held in the YAG lattice was investigated, and the results indicate that only an excess of 0.2 at. % could be contained before the formation of secondary phases.

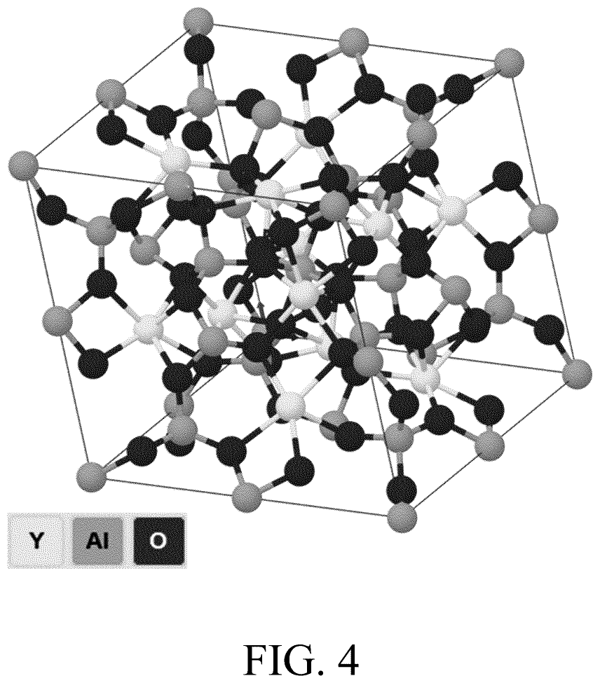

The unit cell of YAG is cubic, a model is shown in FIG. 4. The isotropic nature of the cubic unit cell ensures high transparency is obtainable as effects of birefringence are not present. The high transparency of the material increases the efficiency of photon emission as little light is lost due to absorption or scattering. For each unit cell in the Y₃Al₅O₁₂ lattice, there are eight formula units containing a total of 160 atoms. The representative formula for the crystal is C₃A₂D₃O₁₂, in which the Al³⁺ ions are located at the A and D sites. These sites correspond to the trigonally distorted octahedral and tetrahedral locations, respectively. The dodecahedral site, C, contains the Y³⁺ ion. These cation positions have no degrees of positional freedom. This crystal lattice promotes the substitution of lanthanide or actinide series ions with a 3+ ionic state. The substitutions occur at the dodecahedral sites of the Y³⁺ ions for which a variety of elements, Nd³⁺, Ho³⁺, Yb³⁺, Eu³⁺, etc., have been successfully doped.

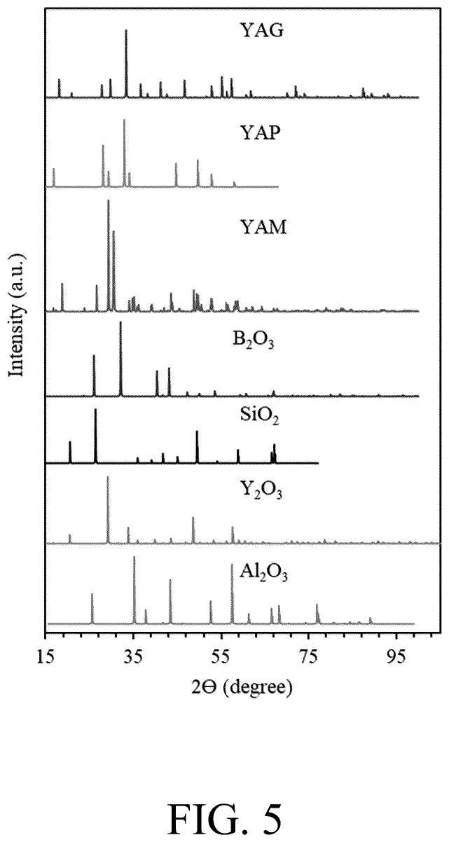

FIG. 5 shows the XRD patterns of YAG, YAP, YAM, B₂O₃, SiO₂, Y₂O₃, and Al₂O₃, respectively, as these phases may be found in the YAG-based polycrystalline, in particular if the polycrystalline is made by SSR method. These references are gathered from the International Center for Diffraction Data (ICDD) database. The spectra of the phases indicate that they are not overlapped with each other, particularly the main peaks of the phases are not overlapped, and thus it is not challenging to identify the phase(s) in a processed sample.

IV. YAG Ceramic Processing

The production of powders, selection of sintering aid, precursor calcination, green body formation, and sintering procedure are each important for determining the final transparency of samples. Each step has multiple methods by which it may be accomplished, each having its own set of parameters. This section describes the conventional sintering (i.e., pressureless sintering) of transparent YAG.

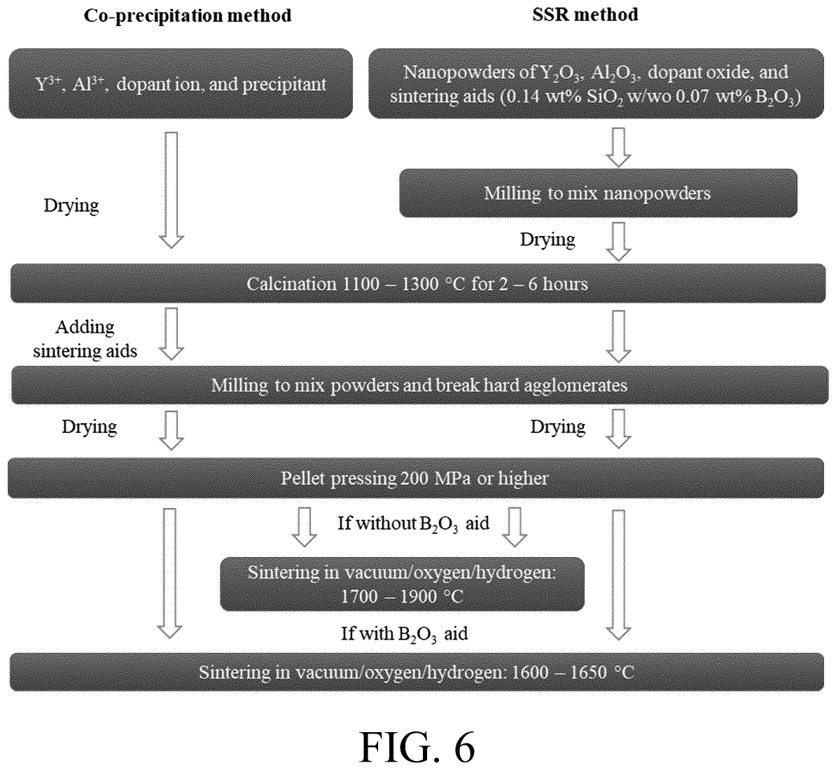

Conventional sintering of YAG is often conducted in a vacuum furnace, however an oxygen atmosphere is also feasible. Two designs of high temperature vacuum furnaces exist. The difference between these furnace designs is the selection of heating material. The tungsten vacuum furnace and graphite vacuum furnace have similar capabilities but use different materials in the hot zone. The former is constructed of tungsten and the latter is constructed of graphite. Post processing is often required when using a graphite vacuum furnace due to the carbon contamination on the sample surface. On the other hand, the oxygen furnace is heated using molybdenum heating elements surrounding an alumina tube filled with flowing oxygen. The fabrication steps of existing literature are all different and the parameters such as time, temperature, rotatory rate, pressure and so on are different to some extent. No consensus appears to be made regarding the exact steps and parameters, while the literature obtained adequate transparency. The commonly applied steps of existing fabrication processes are summarized in the fabrication route map of FIG. 6. The most important steps and parameters and their effects are discussed below.

A. Powder Source

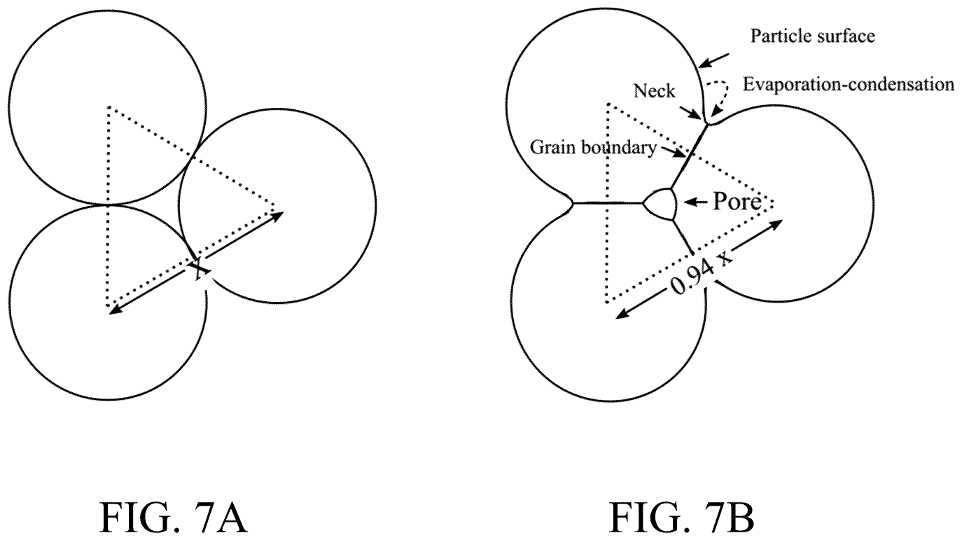

Powder purity and morphology have a significant impact on the ability to sinter transparent ceramic. High purity ensures that no secondary phases are present in the material. As previously stated, the YAG lattice can accommodate at most a 0.2 at. % excess of Al₂O₃ and an excess of 1 at. % Y₂O₃ before the formation of secondary phases. To obtain highly transparent ceramics, nearly all pores must be removed during the sintering process. The initial porosity of the sample is dependent on the morphology of the powder. Ideally, the powder is expected to have a narrow particle size distribution with an average diameter below 300 nm and consist of spherically shaped powders to promote a high particle packing density in the green body. FIGS. 7A-7B show how the powder size and shape impact the initial size of pores within a structure. The open volume within the region bounded by the triangle formed by connecting the centers of the particles (see, FIGS. 7A and 7B) are minimized as the powder size is reduced. Ensuring that the initial pore size is small is critical for obtaining high-density ceramic. A pore larger than the average grain size is thermodynamically stable till grain growth has increased the grain size to destabilize the pore. Nonuniform powder containing hard agglomerates (e.g., particle groups held together by forces stronger than van der Waals forces) can significantly increase the initial pore size as a high packing density is unattainable.

YAG powders may be acquired through two general methods. The first method is SSR which mixes Al₂O₃ and Y₂O₃ nano-powders followed by sintering to convert the oxides to the YAG phase. As such, phase transition and sintering occur synchronously. The second method is through chemical synthesis processes (e.g., co-precipitation, sol-gel, flame spray, etc.) which create either a YAG powder or a precursor that will be calcinated to form YAG. SSR and co-precipitation methods are applied more commonly than other methods.

i. The Solid-State Reaction (SSR) Method

The SSR method starts from the as-received high-purity nano-powders of Al₂O₃ and Y₂O₃ combined in proper stoichiometric ratios. A dopant oxide powder (Nd₂O₃, Yb₂O₃, etc.) may also be added at this stage while adjusting the stoichiometric ratio to account for the dopant. The powders are mixed by ball milling to ensure adequate homogeneity and prevent the formation of secondary phases in isolated regions. The phase transformation of Al₂O₃ and Y₂O₃ to YAG occurs synchronously with sintering or during calcination prior to sintering.

The diffusion mechanism has been investigated between Al₂O₃ and Y₂O₃ which inter-diffuse and react to form YAG during heating. As significant heat is applied, the Al³⁺ atoms are capable of diffusing into the Y₂O₃ particles. By reducing the powder size, the diffusion distance is decreased, resulting in more rapid phase formation and removal of secondary phases. Specifically, the size of the Y₂O₃ particle is critical for these effects to occur. A series of reactions occur during this diffusion, converting the Al₂O₃ and Y₂O₃ powders first to the YAM phase, then the YAP phase, and finally the YAG phase:

Y₂O₃+½Al₂O₃→YAM(900-1100° C.),

(hereinafter “Equation 1”),

YAM+Al₂O₃→YAP(1100-1250° C.),

(hereinafter “Equation 2”), and

YAP+⅓Al₂O₃→YAG(1400-1600° C.),

(hereinafter “Equation 3”).

The formation of these phases is accompanied by large volume changes, an expansion of 5.97% for the YAM phase, a shrinkage of 17.44% for the YAP phase, and an expansion of 11.46% for the YAG phase. These volume changes are significant and may adversely affect the densification; therefore, a calcination step that forms the YAG is implemented prior to sintering. Three methods have been used for sintering SSR powders: no calcination, calcination of powder, and calcination of powder compact (i.e., green body). Calcination of the powder prior to green body and sintering achieves the sample with the highest transparency. The transmittance at 1064 nm-wavelength is 83.28% using the second method, compared to 75.98% the third method and 68.47% the first method. After calcination, a ball milling step is required to break apart agglomerates that are formed during calcination.

The advantage of the SSR method over chemical synthesis methods is that high purity nanoparticles of Al₂O₃ and Y₂O₃ are widely available in various particle size distributions. Additionally, changes in dopant concentration and edits to the stoichiometric ratios of the Al₂O₃ and Y₂O₃ are relatively easy compared to long chemical procedures required for other powder synthesis methods. The disadvantage of using the SSR method is that maintaining stoichiometry during processing may be difficult as the material may absorb water resulting in mass changes. Therefore, working in controlled atmospheric environments is preferable when creating a batch of SSR powder.

ii. The Co-Precipitation Method

The alternative method to the SSR is through the chemical synthesis of YAG powders. Multiple methods that have been reported for achieving YAG and doped YAG powders, including co-precipitation, sol-gel, and flame spray. The co-precipitation method is discussed in the following paragraphs.

The co-precipitation method has multiple parameters that can be adjusted to produce YAG precursor powders of different morphologies and degrees of homogeneity. In general, a cation solution of deionized (DI) water, yttrium nitrate (Y(NO₃)₃), and aluminum ammonium sulfate (NH₄Al(SO₄)₂) is mixed. To produce doped YAG, the dopant is added at this stage by adjusting the stoichiometric ratio between Y(NO₃)₃ and a dopant nitrate such as neodymium nitrate (Nd(NO₃)₃), uranyl nitrate (UO₂(NO₃)₂), cerium nitrate (Ce(NO₃)₃), etc. After mixing, a precipitant solution, consisting of ethanol, DI water, and ammonium hydrogen carbonate ((NH₄)HCO₃), is added to the cation solution for the precipitation purpose and obtain the precipitates of Y₂(CO₃)₃, Y(OH)CO₃, AlOOH, Al(OH)₃, and NH₄Al(OH)₂CO₃ with a diameter of less than 300 nm. The solution is then filtered using a Buchner filter apparatus, or a centrifuge to obtain the precipitates. The precipitate powders are then washed repeatedly and dried in an oven.

The effects of adding ethanol to the precipitant solution has been studied. The ratio of 0.2-1.2 alcohol to water is beneficial to YAG phase formation when the powder is calcinated at 1000° C. The reason for adding alcohol to the solution is to act as a dispersant to promote a more homogeneous mixture of the precipitants. Another discovery is that the chemical reaction should remain below 25° C. to prevent secondary phases from forming.

Important parameters to consider when employing this technique are the molar concentration of the cations in the solution and the ratio between ethanol and DI water in the precipitant solution. The effects of cation concentration on the formation of YAG phase has been investigated. Higher concentration (e.g., 1.5 M) of cations is not conducive to the formation of the YAG phase during calcination due to the formation of YAM, as detected by XRD analysis. Instead, a moderate concentration of 0.5 M of Al³⁺ promotes the formation of YAG phase at a lower calcination temperature. The high concentration results in large Y₂O₃ particles, increasing the diffusion distance for the Al³⁺ ions. Thus, longer calcination times and higher temperatures would be required to remove the excess YAM phase. While using the lower concentration, 0.5 M Al³⁺, the particle formation is uniform between the two materials. The particle size is approximately 100 nm, which promotes YAG phase formation at a temperature of 1050° C.

iii. The Effects of Powder Characteristics

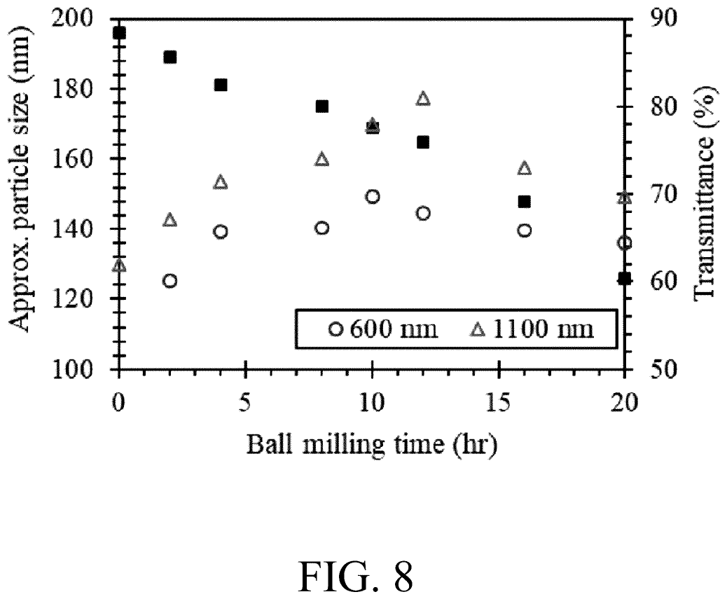

Powder morphology is known to have a significant impact on the transparency of samples after sintering. As shown in FIGS. 7A-7B, initial porosity in a sample prior to sintering is greatly affected by powder uniformity and size. The effect of ball milling parameters on the transparency of Yb:YAG has been studied using the co-precipitation method. A ball milling time of 12 hours can be optimal for reducing agglomerated particles. Extending ball milling past the 12 hours can result in the creation of some large particles despite the average particle size continuing to decrease. These large particles are formed due to small particles becoming attached to the surface of larger particles. The change in particle size and the effect of large agglomerates results in a change in transmittance, as shown in FIG. 8. The light transmittance of Yb:YAG increases about 20% after the 12-hour ball milling compared to no ball milling. The impact of powder morphology on transmittance can be significant.

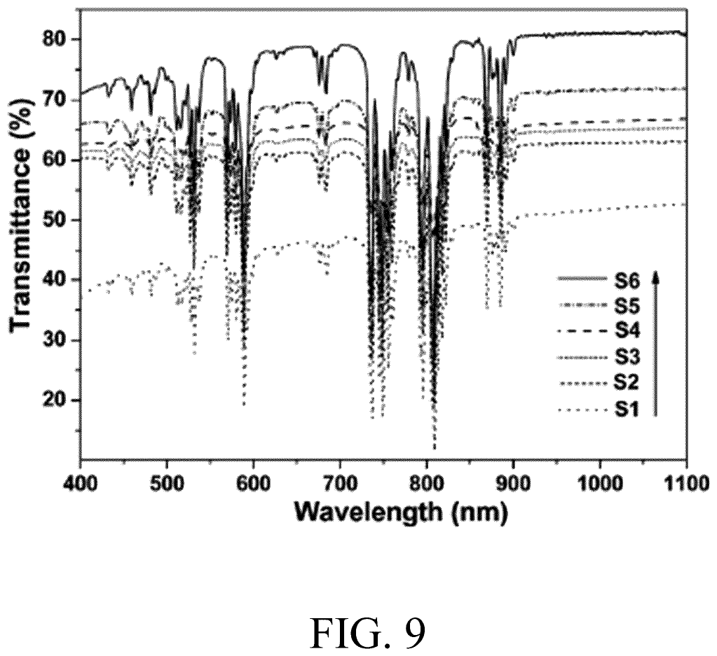

Powder crystallinity was also observed to have a significant effect on the transmittance. Crystallinity refers to the degree of structural order in a solid. The degree of crystallinity is varied by changing the calcination temperature and time of co-precipitated powders. In general, the degree of crystallinity in the Nd:YAG powder could be increased by increasing calcination time and temperature; however, this also increases particle size. FIG. 9 shows the change in transmittance for samples of different crystallinity degrees. Particularly, as shown in FIG. 9, S1-S3 show calcination at 1100° C. for 2 h, 4 h, 6 h, respectively, while S4-S6 show calcination at 1150° C., 1200° C., and 1250° C., respectively for 4 h. Sample S6, which has the highest degree of crystallinity due to the calcination parameters 1250° C. for 4 hours, has the highest transmittance at 81% for 1064 nm despite having the largest particle size of approximately 260 nm. In comparison, sample S1 has a powder size of approximately 60 nm but only has a transmittance of 52% at 1064 nm. Calcination was conducted at 1100° C. for 2 hours for this sample. Transmission electron microscopy (TEM) images reveal that the S1 powder contains a 4-nm thick amorphous or defect-rich layer while the S6 powder has no such layer. This layer was undetectable by XRD; therefore, the importance of crystallinity may not always be reported.

B. Calcination

Calcination is an important step to convert the precursor powders obtained from chemical synthesis into the YAG phase. The procedure is also often implemented when performing sintering using SSR powders to prevent large volume expansion and contraction during sintering. The effect of calcination on the formation of the YAG phase has been reported in several publications, though no consensus appears to be made regarding the exact temperature and time which should be applied to the precursor powders. Therefore, the calcination procedure is likely entwined with the powder synthesis procedure, which would account for the variation in results.

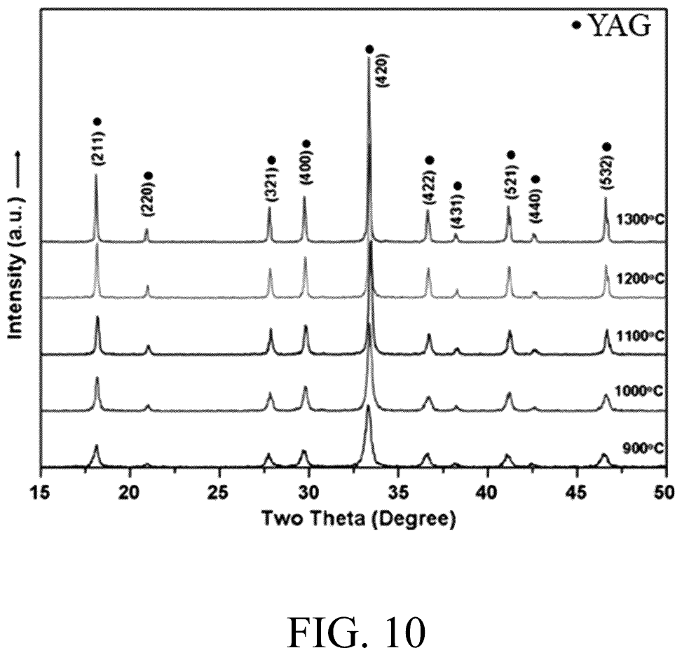

The effects of calcination temperature on the ability of co-precipitated powders to be sintered has been investigated, concluding that the ideal calcination procedure is two hours in air at a temperature between 1100° C. and 1300° C. The XRD results of the calcination study are shown in FIG. 10. From these XRD patterns, it is apparent that as the calcination temperature raises the peaks are sharper and narrower, indicating a higher degree of crystallinity. However, the method of YAG powder formation does have an impact on the calcination temperature that should be applied. Using the SSR, the effects of calcination temperature on YAG transparent ceramics was investigated. It was reported that a calcination temperature higher than 800° C. improved the mechanical strength of the ceramic, while a calcination temperature of 1100° C. had a negative effect on the optical transmittance of the ceramic. Thus, the best calcination temperature was reported to be 1000° C. for six hours in air. Both the temperature and time of calcination were impacted by the powder process. Therefore, careful consideration must be made when choosing a calcination temperature in combination with the powder fabrication method.

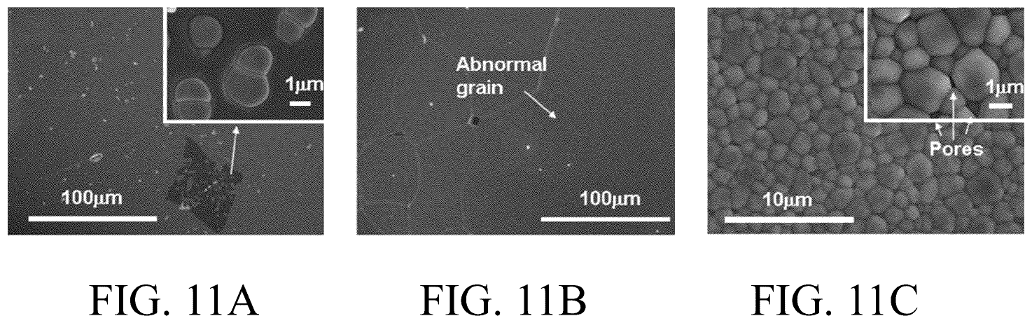

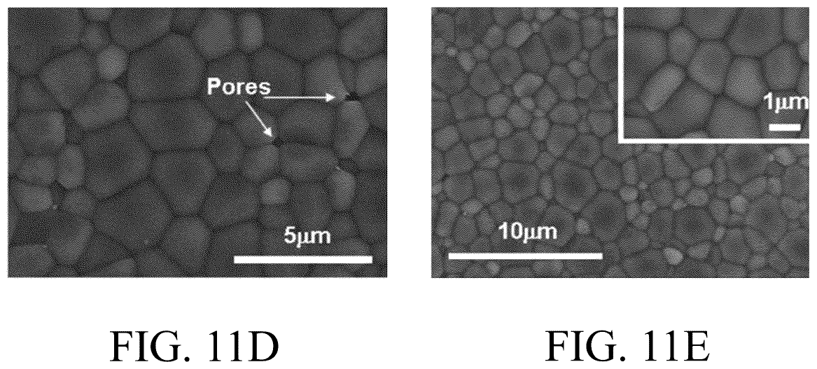

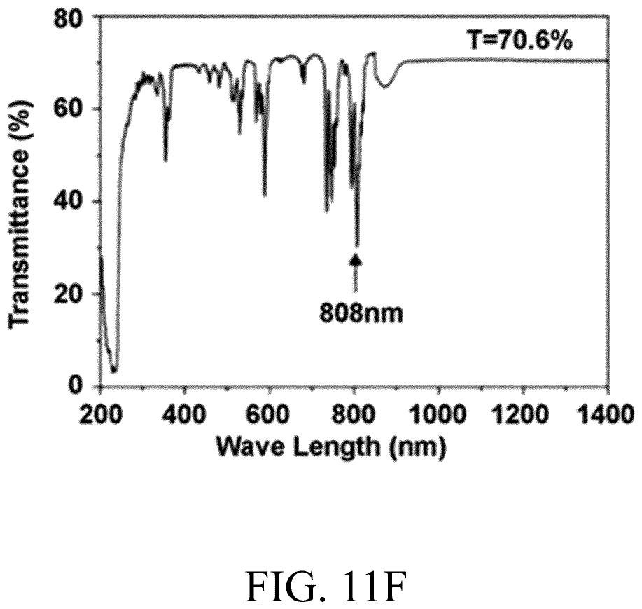

The impact of calcination on microstructure development during sintering was investigated. It was stated that powders calcinated at a low temperature of 900° C. or 1000° C. had excessively high sintering activity resulting in abnormal grain growth leading to pore formation, as shown in FIGS. 11A-11B. While those produced at a temperature higher than 1100° C. were found to have a uniform grain distribution, increased transparency, and fewer pores, as shown in FIGS. 11C-11E.

To produce U:YAG powders, a calcination procedure of eight hours at a temperature of 800° C. in an oxygen atmosphere after green body formation for SSR powder has been used. Sintering may then be conducted at 1900° C. for 10 hours resulting in transparent U:YAG with the U⁴⁺ ion substituting into the Y³⁺ lattice position. A U⁴⁺ substitution into the Y³⁺ lattice position was attainable by calcinating in an atmosphere of N₂ with 3% H2 at 1000° C. for four hours. Other have performed calcination in an air atmosphere at 1250° C. for four hours. The samples were then sintered in a graphite heated vacuum furnace at 1800° C. for 15 hours resulting in transparent U:YAG with the U⁶⁺ ion substituting into the Y³⁺ lattice position.

C. Green Body Formation

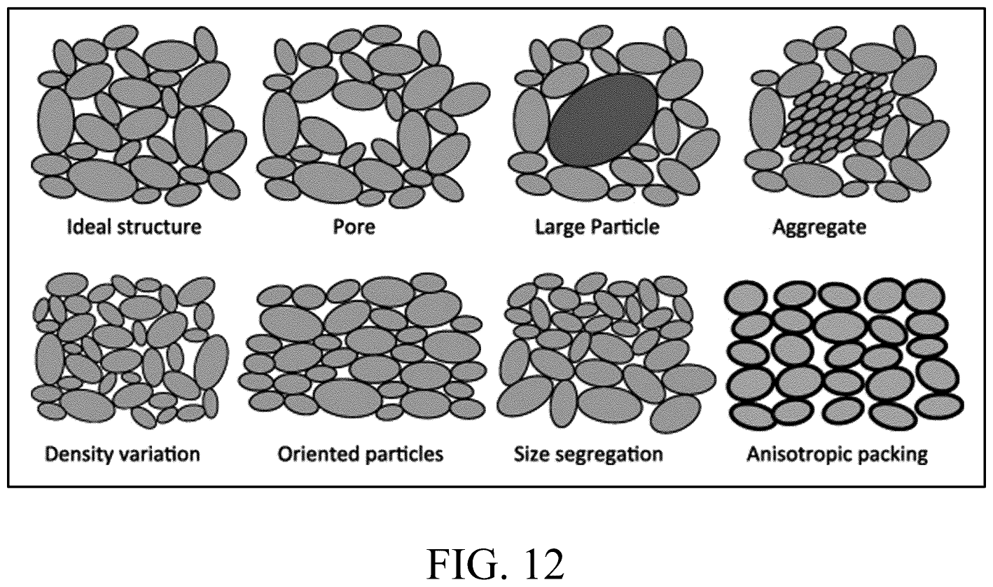

A high-density green body indicates a low initial porosity, thus leading to a highly densified sample at lower temperatures and shorter times during sintering. As residual pores drastically reduce the transparency of ceramic, a low initial porosity is desired. FIG. 12 depicts how the density of a green body is altered by the morphology of powder and the distribution of powder sizes within the green body. To obtain a high-density green body, the morphology of powder is the most critical factor, followed by the compaction method. To produce transparent YAG ceramics, pores need to be reduced or eliminated. To eliminate pores, powders need to be nanometer size and uniform in shape.

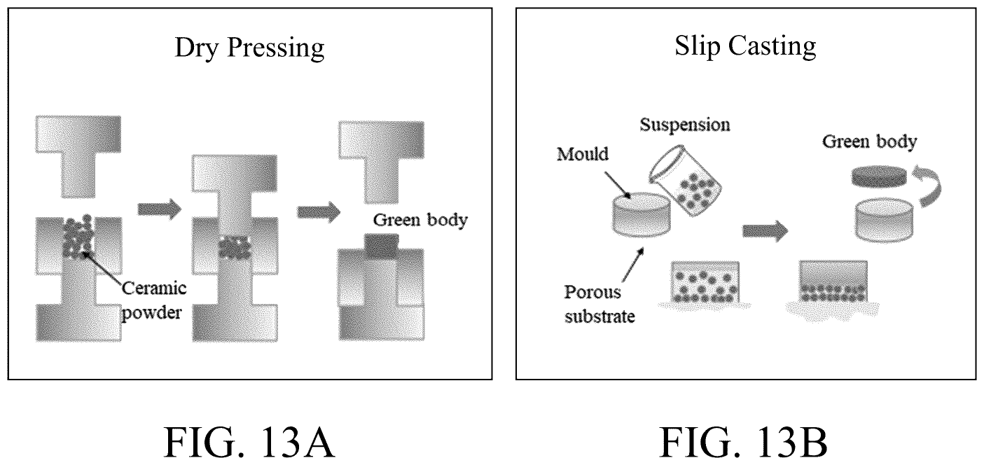

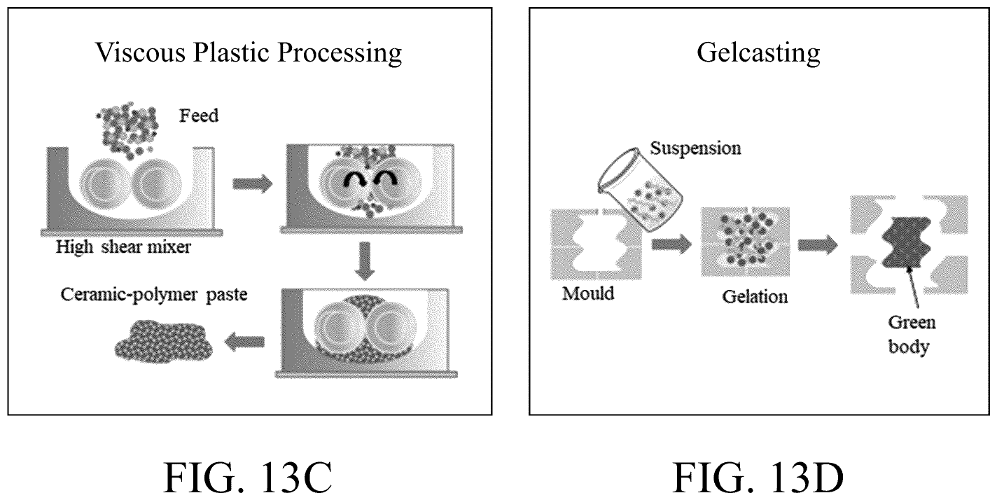

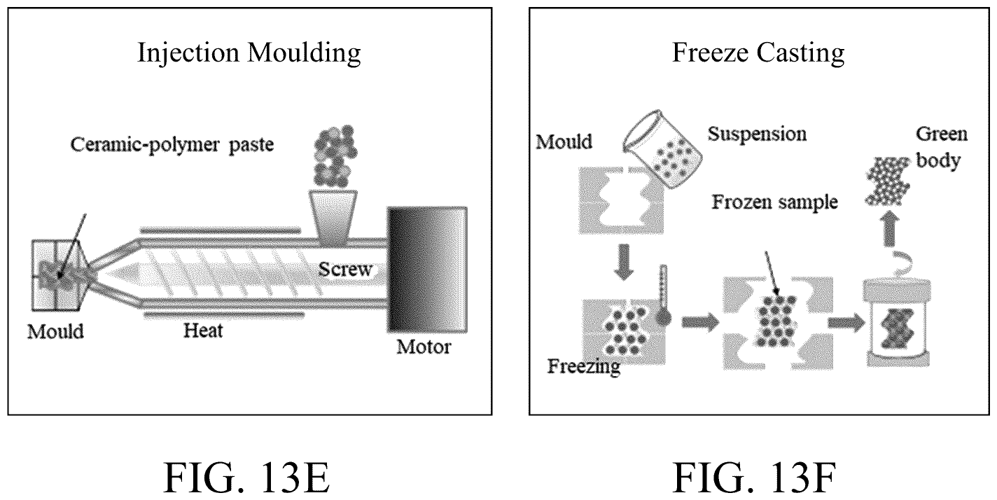

In addition to the powder property, the pressure that densifies powders into solid compact is another critical factor. The formation of YAG green bodies can be accomplished through various methods, including uniaxial pressing (or “dry pressing”) (see, FIG. 13A), cold isostatic pressing (CIP), and colloidal processing. A schematic depicting many different types of consolidation methods is shown in FIGS. 13A-13F. Uniaxial pressing or dry pressing (see, FIG. 13A) uses a set of cylinders with a false bottom that allows for the formation of a pellet under pressure. Uniaxial pressing is often reported in combination with CIP but can also be used independently. A pressure in the range of 200 MPa is reported for independent usage, while 20 MPa followed by 200-MPa CIP is reported when used in combination. A CIP consists of a chamber of fluid in which the sample is placed while the fluid is compressed, leading to a uniform pressure applied to the sample in all directions. Careful attention should be taken to ensure that contamination of the sample does not occur while in the fluid chamber. A pressure of 200 MPa is commonly reported in procedures for fabricating transparent YAG samples. Colloidal processing refers to multiple methods involving the use of a suspension of particles in a fluid to form the desired shape. These methods are known to produce a denser and more uniform green body. This is because the immersion in a fluid reduces the van der Waals attractions and allows for better packing. Additionally, colloidal processing is better able to remove agglomerates as the solution can be easily filtered prior to consolidation. Other methods of colloidal processing include slip casting (see, FIG. 13B), tape casting, viscous plastic processing (see, FIG. 13C), gelcasting (see, FIG. 13D), injection moulding (see, FIG. 13E), freeze casting (see, FIG. 13F), etc.

D. Sintering

Sintering is the process of consolidating the powder compact into a solid by reducing the porosity from the initial value of 40-50%. For transparent polycrystalline YAG, the final porosity may be less than 0.1%. The reduction of porosity is accomplished through the application of heat and/or pressure, which facilitates densification through grain rearrangement and growth. Sintering temperature is often at 50-80% of the material's melting point to ensure that geometric shape can be obtained while also promoting densification. Sintering techniques primarily apply heat to the samples to promote densification; however, pressure and electric current are often applied in combination with heat. YAG is often treated with pressure during sintering through either hot isostatic press (HIP), hot press (HP), or spark plasma sintering (SPS), as pressure is highly effective at eliminating pores. Sintering of transparent polycrystalline YAG has been achieved through various techniques including vacuum furnace, SPS, HIP, microwave, and two-step sintering. However, the most common method for YAG production is the use of conventional furnaces. These have the benefit of producing samples of unrestricted dimensions as complicated pressure chambers are not required. Conventional sintering of YAG is conducted in a vacuum to promote the diffusion of gas out of the sample pores; however, recent work reported that sintering in oxygen is also feasible. This discussion focuses on conventional sintering in both oxygen and vacuum.

Sintering is a thermodynamically irreversible process and is accompanied by the reduction of free energy in the system. The driving forces for the reduction in free energy are curvature of particle surfaces, externally applied forces, and chemical interactions. The particles within the green body undergo geometric change during sintering which is divided into three stages. In the initial stage, necks form between adjacent particles, increasing the contact area of the particles and improving relative density to ˜60%. The intermediate stage of sintering begins when grain growth first occurs. The microstructure of the material during this stage consists of a pore phase and a grain phase. Pores remain connected throughout the material and are bounded by grain boundaries which results in irregularly shaped pores. As the connections between the pores are closed, the final stage of sintering has begun. Pores that are connected to grain boundaries can then continuously shrink until eliminated. However, a second version of the final sintering stage can occur if non-uniform grain growth is present. In this process pores may become isolated from grain boundaries and become unable to shrink in size. This is because pores are a collection of vacancies in the lattice; therefore, without access to grain boundaries, which act as sinks for the vacancies, elimination cannot occur.

Two parameters are often used to describe the microstructural evolution of a material during the sintering process. These are the average grain size and the relative or theoretical density. Relative or theoretical density is commonly stated as a percentage of the theoretical maximum density of a material. The converse of relative density is the porosity of the sample, which is related as one minus the relative density. Additionally, linear shrinkage or volume shrinkage can be measured during heating to determine the stage of sintering.

i. Sintering in a Vacuum Atmosphere

The first report of successful fabrication of Nd:YAG polycrystalline transparent ceramics with qualities similar to that of single crystals was made in 1995. The samples were fabricated using conventional sintering in a vacuum at 1750° C. for 20 hours. A sintering aid of 0.14 wt. % SiO₂ was added to the SSR powders used in the fabrication. The in-line transmittance of the sample at 1064 nm was approximately 80%. Sintering in vacuum atmosphere has continued to be the most prominent method in literature for sintering transparent YAG. Sintering in vacuum is common for transparent ceramics as the pressure difference between gas trapped in pores and the vacuum leads to more rapid pore elimination.

Fabrication of transparent polycrystalline U:YAG has been reported using conventional sintering in a vacuum. These experiments used co-precipitation and SSR methods, and different furnace types, though similar results were obtained. One experiment used a graphite heated vacuum furnace to sinter powder compacts at 1800° C. for 15 hours, obtaining a sample with a maximum transmittance of 78% in the visible spectrum. Another used a tungsten heated vacuum furnace at 1900° C. for 10 hours, obtaining in a sample with a transmittance of 79.04% at 714 nm. Both used CaO as a sintering aid, which requires higher sintering temperature and longer time than the sintering aid of SiO₂.

Fabrication of thick YAG is often difficult as inner pores may be closed from the surrounding atmosphere much sooner than the pores closer to the surface. Successful fabrication of thick YAG samples has been observed through sintering in a vacuum. Small pellets, 5 mm in thickness, were fabricated to transparency. Additionally, a large dome measuring 120 mm in diameter by 15 mm in thickness was also sintered to transparency. This work represents a significant breakthrough in YAG transparent ceramics as the complex shape and thickness had yet to be reported. Sintering of the pellets required 1750° C. for 10 hours in a tungsten heated vacuum furnace with sintering aid of 0.14 wt. % SiO₂. Sintering of the dome required 1750° C. for 30 hours. The powder used was produced by SSR with a critical calcination step occurring after green body formation. The temperature of calcination was 1000° C. for six hours; this step was stated as the reason the thick samples could be fabricated at high transparencies. The in-line transmittances at 1000 nm for the pellet and dome were 82.9% and 80.1%, respectively.

ii. Sintering in an Oxygen Atmosphere

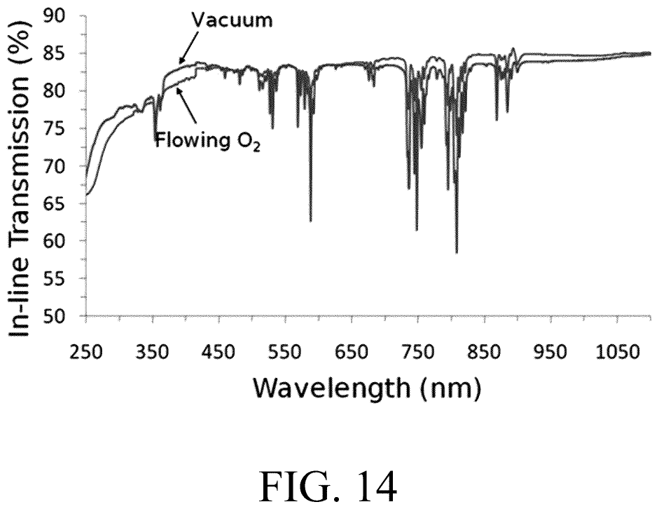

A high-temperature vacuum furnace is more time- and cost-consuming than a non-vacuum furnace, and thus, a more affordable and efficient method is desired. Polycrystalline Nd:YAG has been sintered in an oxygen atmosphere furnace and obtained transparent Nd:YAG. The powder was made by SSR method, with sintering aid of 0.14 wt. % SiO₂, and ball milled for 12 hours. The Nd:YAG was sintered in oxygen atmosphere at 1710° C. for three hours, obtaining in-line transmittance of 80% at 1064 nm and a relative density of 99.5%. This relative density is equivalent to samples sintered in a vacuum furnace. Therefore, it is feasible to achieve transparent YAG-based ceramics in the oxygen atmosphere. Transparent polycrystalline Nd:YAG ceramics have also been obtained through sintering in oxygen atmosphere. Using the combined sintering aids of SiO₂ and B₂O₃, the sintering dwell temperature can be reduced from >1700° C. to 1600° C. The 1600° C. can be carried out in a less expensive furnace and thus lowers the manufacturing cost. Using the combination of sintering aids, the Nd:YAG samples sintered in different atmospheres (i.e., flowing oxygen and vacuum) at 1600° C. for 20 hours had comparable in-line transmittance plots, as shown in FIG. 14. Both samples are highly transparent with in-line transmissions approaching 84% from 400 to 1100 nm. The light transmission at 250-400 nm of the sample sintered in flowing oxygen is relatively lower than the one sintered in vacuum.

It is noted that, though vacuum and non-vacuum atmosphere are both feasible methods, the non-vacuum atmosphere is constrained by the types of gas. The size of gas molecules must be small to rapidly diffuse out of the material. Using the same synthesis and sintering parameters to make the Nd:YAG samples, the argon atmosphere furnace yielded a relative density of only 98.1% while the oxygen atmosphere furnace yielded 99.5%. This is because solid-state diffusion is required during the final stage of sintering. When pores become isolated, the difference in relative density is a result of the slow diffusion rates of the large argon atoms compared to the oxygen atoms. This finding is consistent with experiments which investigated the effect of the atmosphere on the densification of Al₂O₃. It was reported that atmospheres of hydrogen, vacuum, and oxygen could be used to sinter pore free Al₂O₃ while nitrogen, argon, and helium inhibited densification.

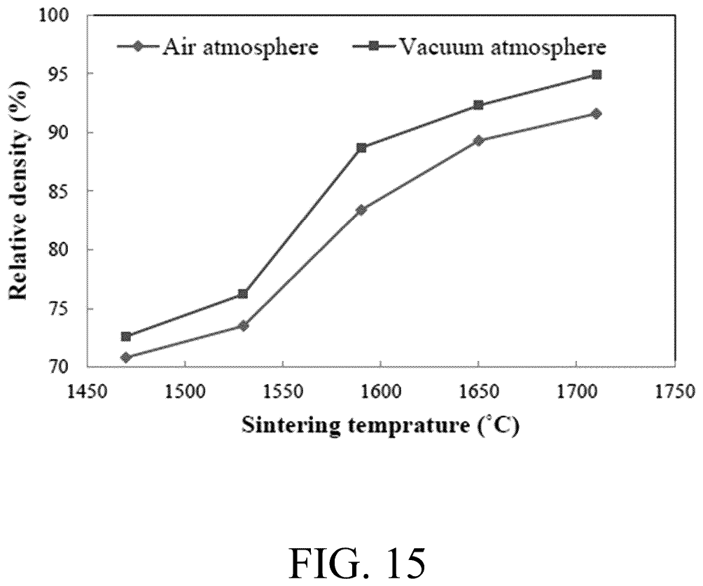

Another example is from an air-atmosphere sintering work of YAG. Solid-state powder was formed by ball milling for 16 hours with 0.14 wt. % Sift added as a sintering aid. Sintering was then performed at 1710° C. for 12 hours. The air sintered samples were reported to have a relative density of 97.3%, while in a vacuum the samples would be 99.8%. FIG. 15 shows the change in relative density for samples sintered in a vacuum compared to air as a function of sintering temperature with a dwell time of six hours. The reason for the difference in relative density was determined to be a result of the slow diffusion of air (primarily nitrogen) out of the crystal once the pores were closed to the surrounding atmosphere in the final stages of densification. Solid-state diffusion is required to eliminate the final pores in the material; however, the slow diffusivity of nitrogen resulted in slow diffusion out of the material and the inability to be incorporated into the lattice.

E. Sintering Aids

Sintering aids are often needed to obtain highly dense ceramic through both pressureless and pressure-assisted sintering methods. The addition of a sintering aid has multiple desired effects on the sintering process, including reduced sintering time, decreased sintering temperature, and increased density. The maximum amount of sintering aid that can be added to enhance sintering is limited by the formation of secondary phases, which may reduce material's transparency. During heating, sintering aids melt to form a liquid phase, which facilitates diffusion of atoms of YAG toward pores and thus promotes densification. At the onset of liquid formation, the liquid wets the powder surface, spreading to fill the pores and dissolving bonds that are formed during initial heating. The liquid phase is soluble in YAG solid, which prevents the formation of secondary phases. As such, the additive chosen must ensure mutual solubility between the solid and liquid. Pores that remain in the sample past the wetting and diffusion stages must be removed by solid-state sintering.

Due to the high temperatures and long periods required to sinter YAG-based polycrystalline ceramics, sintering aids are used to support sintering mechanics and increase the densification rate and/or limit grain growth. The sintering aid is typically mixed with YAG powder in quantities of less than 1 wt. % through ball milling to ensure homogenous distribution. Sintering aids that have been used for YAG include calcium oxide (CaO), silicon oxide (SiO₂), boron oxide (B₂O₃), and magnesium oxide (MgO).

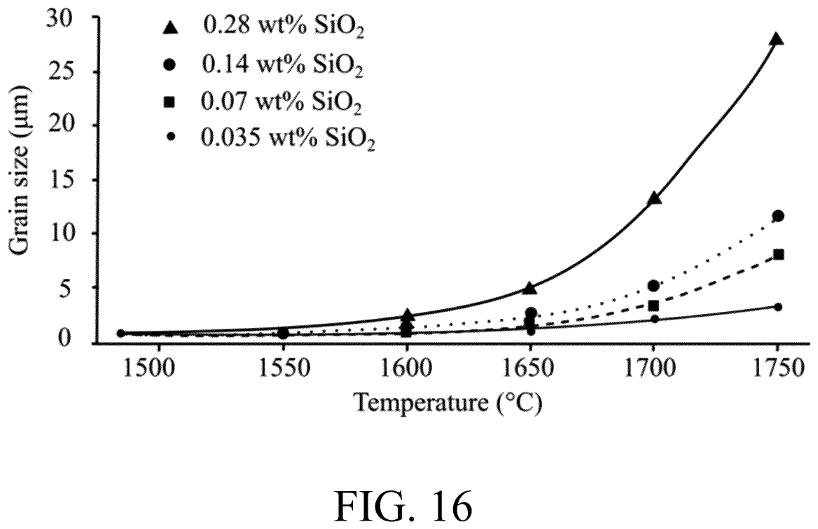

It was determined that the sintering aid is important for producing fully transparent samples with laser slope efficiencies. The use of SiO₂ as the sintering aid has become standard in the fabrication of transparent YAG. Often, the SiO₂ is added in the form of tetraethyl orthosilicate (TEOS). TEOS is preferred because it is a liquid, therefore promoting a more homogenous distribution of sintering aid throughout the powder. TEOS breaks down into SiO₂ during the heating process. A doping concentration of 0.28 wt. % increases the density of the samples at all sintering times and temperatures. Nd:YAG with 0.14 wt. % SiO₂ samples sintered in a vacuum furnace could reach a relative density of 99.9% in two hours at temperatures higher than 1650° C. However, the issue with SiO₂, which has promoted further study into sintering aids, is excessive grain growth during sintering. The effects are shown in FIG. 16, showing that an increase in SiO₂ increases the grain growth rate. Grain size, as long as grains are uniform in size, does not affect light transmittance, though ceramics with finer grains are preferred in applications that require robustness in high strength.

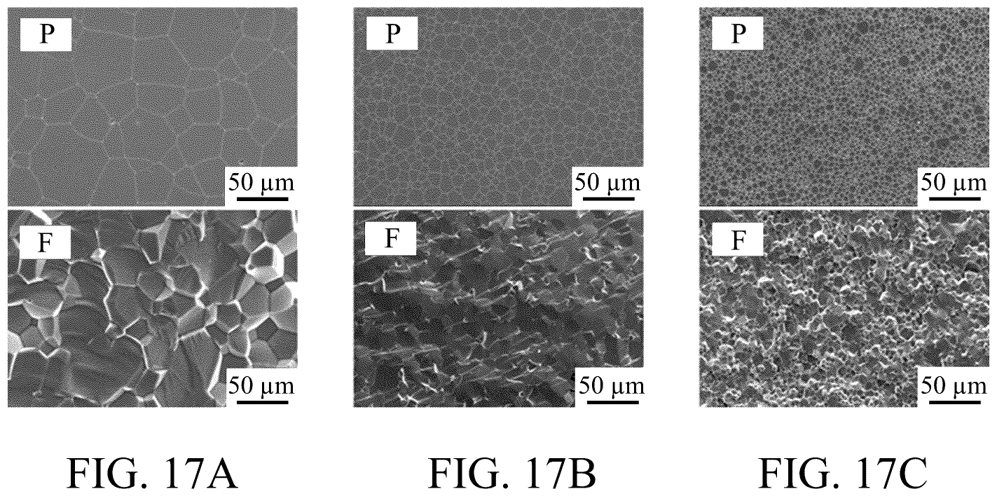

A solution to the issue of grain growth is to use a second sintering aid MgO in addition to SiO₂. The effect of MgO on YAG ceramics is that grain growth for samples without aid is abnormal due to the low homogeneity of powders, while the addition of MgO makes grain boundary mobility more uniform, resulting in a narrow distribution of grain sizes. The suggested amount of MgO is 0.0₃ wt. %, an increase from this value has a detrimental effect on grain size and distribution. This sintering aid also has an impact on the transparency of samples when sintered at 1750° C. for 10 hours, as the YAG sample containing no MgO was found to be non-transparent, while any addition of MgO below the solubility limit lead to a transparent sample. The addition of MgO at or above the solubility limit reduces transparency due to the formation of secondary phase. Commonly, both SiO₂ and MgO are used together to promote densification and limit grain growth. As noted previously, SiO₂ is the dominant driver for the densification mechanics of samples and can result in excessive grain growth. MgO is then used to limit grain growth during sintering. SEM images of Nd:YAG samples sintered with various compositions of the two sintering aids are shown in FIGS. 17A-17C. It is evident that 0.145 wt. % SiO₂+0.10 wt. % MgO would result in smaller grain size and mitigate pores compared to the single addition of SiO₂ or MgO, respectively.

Calcium oxide is another sintering aid to replace the SiO₂ sintering aid. The optimal concentration of CaO is suggested to be 0.045 wt. % as which promotes densification without excessive grain growth. The advantage of CaO compared to SiO₂ is that CaO can increase the densification rates while also limiting the grain growth to prevent the formation of large grains, which occurs when doping with only SiO₂. However, the stronger effects of SiO₂ on the densification rate of the samples lead to significantly reduced sintering temperatures and hold times. Because of this effect, CaO is used less often as a higher temperature furnace is required to obtain transparent YAG.

Boron oxide (B₂O₃) is another sintering aid aimed at further reducing the sintering temperature for transparent Nd:YAG ceramics. The method came from the experience of sintering cordierite (Mg₂Al₄Si₅O₁₈), in which co-doping with SiO₂ is known to reduce the sintering temperature and time. The investigation successfully fabricated transparent Nd:YAG at temperatures as low as 1600° C. The optimal doping concentration was suggested to be 1.35% mol (equivalent to 0.14 wt. % SiO₂) with the ratio of B₂O₃:SiO₂ at 0.5. It is also noted that the addition of B₂O₃ reduces the grain growth which occurs with SiO₂. Further research needs to be carried out to understand how B₂O₃ facilitates densification at a lower temperature while inhibiting grain growth. In addition, one of the limitations of the sintering method for producing transparent polycrystalline ceramics is the cost of sintering. As YAG sintering can require high temperatures (˜1750° C.) and/or high pressures (˜90 MPa), the costs and availability of equipment are a concern; thus, improved solutions are desired. The sintering temperature can be decreased from ˜1750° C. to 1600° C., which can allow the application of a significantly less expensive furnace and reduces the energy consumption. The 1600° C. furnace is more suitable for large-scale and high-throughput productions compared to higher temperature furnaces, vacuum furnaces, or pressure-assisted furnaces (i.e., SPS and HIP).

V. Exemplary Methods of Fabricating Transparent Polycrystalline U:YAG Ceramics

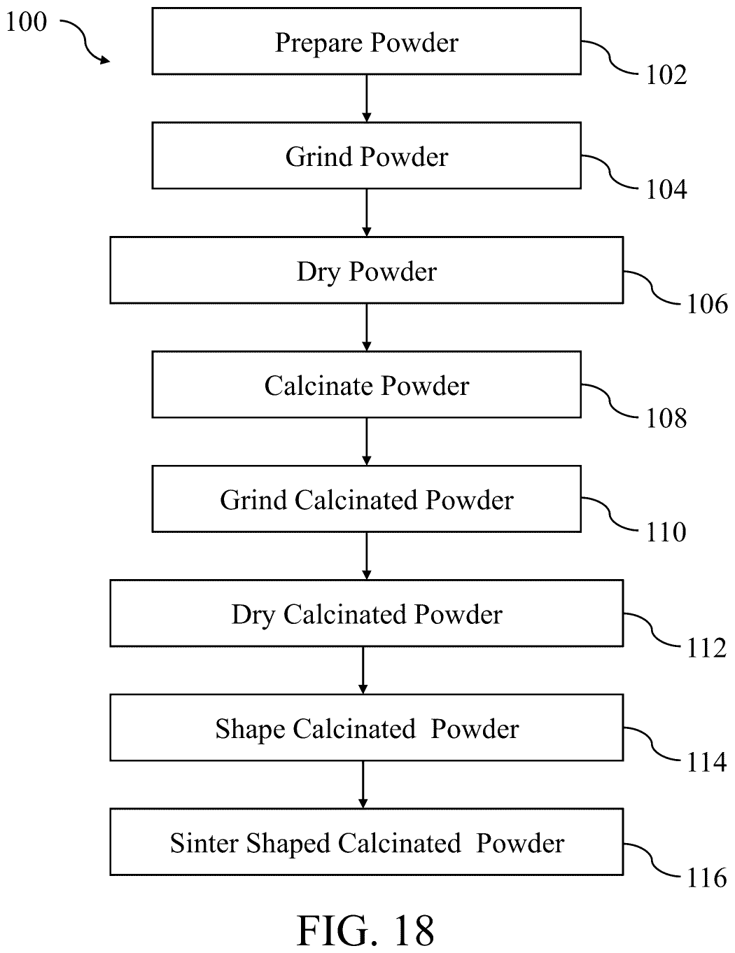

As described above, fission energy produced from fissionable (e.g., U-238) and fissile (e.g., U-235) isotopes can provide sufficient energy to cause luminescence in a host material. The intensity of luminescence may be correlated to the neutron flux, therefore providing a method of measuring reactor power with a rapid response time. YAG, as presented herein, can accommodate the fissionable and fissile isotopes into its crystal lattice. While several methods utilizing various parameters can be utilized to formulate U:YAG to accomplish the functions described, one such method can include one or more of the steps of the method (100) shown in FIG. 18 and described in greater detail below.

At step (102), the method can begin with preparing the powder. In some embodiments, the powder can be prepared using a solid-state reaction (SSR) method, while in other embodiments it can be prepared using a co-precipitation method. The SSR method is described in greater detail. This SSR method combines solid yttria (Y₂O₃) powder, alumina (Al₂O₃) powder, and a chemical including the U isotope. Some non-limiting examples of chemicals including the U isotope are uranyl nitrate hexahydrate (UO₂(NO₃)₂·6H₂O), uranium oxide (UO₂), non-hydrated uranyl nitrate, or one of many alternatives. In alternative embodiments, the U isotope may be replaced by other fissionable and fissile isotopes, for example, Th-232, Np-239, Cf-252, Am-241, U-233, Pu-239, or any one of many others. The combination may be combined in stoichiometric ratios to form uranium (U)-doped yttrium aluminum garnet (U:YAG) by a reaction at high temperatures. The weighing and combination of the powders can be conducted in an inert gas-filled glove box, as described in the following paragraph, with moisture level of less than one ppm to prevent moisture from accumulating on the powders.

More particularly, one non-limiting example of a weighing and combination process can include, firstly, weighing Y₂O₃ powder (e.g., particle sizes of 50-70 nm), Al₂O₃ powder (e.g., particle size of 250-450 nm), and UO₂(NO₃)₂·6H₂O crystals at 2.853 g, 2.174 g, and 0.0085 g, respectively. Secondly, the weighted Y₂O₃, Al₂O₃, and UO₂(NO₃)₂·6H₂O are placed into the 100-ml YSZ grinding jar. Next, 20 g 6-mm-diameter and 10-mm-diameter YSZ balls are weighed, and balls placed into the YSZ grinding jar. Next, the process includes weighing 40 g of ethanol and pouring the ethanol into the YSZ grinding jar. Finally, the process includes using the micropipettes to get 27 μL tetraethyl orthosilicate liquid (99.9%) and 5.4 μL trimethyl borate liquid (99.99%), and adding all powders into the YSZ grinding jar to mix the sintering aides in. It should be noted, however, that the weights can be changed according to the demand.

At step (104), the mixture is ground. In one example, the mixture can be ground using a ball milling procedure. In such a procedure, the rotatory speed can be set to around 200 rpm in a bidirectional mode with approximately 25-minute cycle times and 5-minute cooldown times for a total of approximately 12 hours.

At step (106), the powder can be dried. Optionally, the drying procedure can include first pouring the contents of the grinding jar through a sieve, such as a 40-mesh sieve, into an evaporation dish to remove the balls. Then, the slurry can be placed on the dish with a lid and heated in a furnace at approximately 110° C. for around 24 hours.

At step (108), the dried powder can be calcinated. In one example calcination procedure, the alumina tube furnace can be used to calcinate the solid powders at around 1100° C. so that the YAG phase is formed. The YSZ sintering boats may be used for this step. More particularly, one example of this procedure can include heating the dried powder from room temperature to around 1100° C. with the heating ramp rate of 5-10° C./min, holding at the dwell temperature at 1100° C. for a dwell time of approximately six hours, and cooling from the dwell temperature to room temperature with a cooling ramp rate of 5-10° C./min.

At step (110), the calcinated powder can be ground again. In one example procedure, ball milling can be used for this step (110). For example, this step can include weighing 20 g 6-mm-diameter and 10-mm-diameter YSZ balls and placing the balls into the 100-ml YSZ grinding jar, weighing 40 g of ethanol and pouring the ethanol into the YSZ grinding jar, and setting the rotatory speed at around 400 rpm in bidirectional mode with approximately 25-minute cycle times and 5-minute cooldown times for a total of around 20 hours. At step (112), the powder can be dried again, such as by repeating step (106) or using a similar drying technique. In some embodiments of method (100), the dried powder can be again sieved such as by using, for example, a 200-mesh sieve with a brush.

At step (114), the calcinated and dried powder can be shaped. In one embodiment of the method (100), a uniaxial hydraulic press can be utilized to press the powder to a pellet or a cylindrical shape with a pressure of around 300 MPa. The size can be changed according to the application and demand.

At step (116), the shaped calcinated powder can be sintered. While there are various methods available for sintering, two such methods will be described in detail below. In the first variation, an aluminum tube furnace may be used. The first method can include steps such as placing the green body in a YSZ boat and put it inside the alumina tube furnace, vacuuming the tube for five minutes, filling the tube with oxygen, repeating these steps 2 and 3 around three times, starting oxygen flow in the tube and the flow meter to regulate the flow to 1.5 L/min with the vacuum pump off, heating from room temperature to high with the heating ramp rate of 5-10° C./min, holding at the dwell temperature at 1600° C.-1700° C. and dwell time of 10 hours, and cooling from the dwell temperature to room temperature with the cooling ramp rate of 5-10° C./min.

In the alternative, second method for step (116), a tungsten mesh vacuum furnace may be used. Accordingly, the sintering steps can include placing the green body inside the vacuum furnace, vacuuming the furnace, heating from room temperature to high with the heating ramp rate of 5-10° C./min, holding at the dwell temperature at 1600° C.-1700° C. and dwell time of around 10 hours, and cooling from the dwell temperature to room temperature with the cooling ramp rate of 5-10° C./min.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A method of fabricating a material, comprising:
(a) preparing a powder mixture including yttrium aluminum garnet doped with a fissionable isotope;
(b) grinding the powder mixture to form a first milled powder;
(c) drying the first milled powder;
(d) calcinating the first milled powder to form a calcinated powder;
(e) grinding the calcinated powder to form a second milled powder;
(f) drying the second milled powder;
(g) shaping the second milled powder to form a plurality of shaped material portions; and
(h) sintering the plurality of shaped material portions.

2. The method of claim 1, wherein the fissionable isotope includes a uranium isotope.

3. The method of claim 1, wherein the powder mixture includes solid yttria (Y₂O₃) powder, alumina (Al₂O₃) powder, and the fissionable isotope in stoichiometric ratios.

4. The method of claim 1, wherein preparing the powder mixture includes performing a solid-state reaction (SSR) powder formation method.

5. The method of claim 1, wherein grinding the powder mixture to form a milled powder includes performing a first ball milling process.

6. The method of claim 1, further comprising:
prior to drying the first milled powder, straining the first milled powder.

7. The method of claim 1, grinding the calcinated powder to form a second milled powder includes performing a second ball milling process.

8. The method of claim 1, wherein drying the first milled powder includes:
(i) placing the first milled powder into a furnace; and
(ii) heating the first milled powder in the furnace at approximately 110° C. for at least 24 hours.

9. The method of claim 1, wherein calcinating the first milled powder includes:
(i) heating the first milled powder from approximately room temperature to above 1000° C.;
(ii) holding the first milled powder at a dwell temperature above 1000° C. for a dwell time period; and
(iii) cooling from the dwell temperature to approximately room temperature.

10. The method of claim 9, wherein the dwell time period is greater than five hours.

11. The method of claim 1, further comprising:
prior to shaping the second milled powder, straining the second milled powder.

12. The method of claim 1, wherein shaping the second milled powder includes activating a hydraulic press, wherein the plurality of shaped material portions form one or more of cylinders or pellets of the second milled powder.

13. The method of claim 1, wherein sintering the plurality of shaped material portions includes activating an alumina tube furnace.

14. The method of claim 1, wherein sintering the plurality of shaped material portions includes activating a tungsten mesh vacuum furnace.

15. A method of fabricating a material, comprising:
(a) preparing a powder mixture including yttrium aluminum garnet doped with a uranium isotope;
(b) grinding the powder mixture to form a first milled powder;
(c) calcinating the first milled powder to form a calcinated powder;
(d) grinding the calcinated powder to form a second milled powder;
(e) shaping the second milled powder to form a plurality of shaped material portions; and
(f) sintering the plurality of shaped material portions.

16. The method of claim 15, wherein the powder mixture includes solid yttria (Y₂O₃) powder, alumina (Al₂O₃) powder, and the uranium isotope in stoichiometric ratios.

17. The method of claim 15, further comprising:
prior to calcinating the first milled powder, drying the first milled powder.

18. The method of claim 17, wherein drying the first milled powder includes:
(i) placing the first milled powder into a furnace; and
(ii) heating the first milled powder in the furnace at approximately 110° C. for at least 24 hours.

19. The method of claim 15, wherein shaping the second milled powder includes activating a hydraulic press, wherein the plurality of shaped material portions form one or more of cylinders or pellets of the second milled powder.

20. A method of fabricating a material, comprising:
(a) preparing a powder mixture including yttrium aluminum garnet doped with a fissionable isotope;
(b) grinding the powder mixture to form a first milled powder;
(c) calcinating the first milled powder to form a calcinated powder, wherein calcinating the first milled powder includes:
(i) heating the first milled powder from approximately room temperature to above 1000° C.;
(ii) holding the first milled powder at a dwell temperature above 1000° C. for at least five hours; and
(iii) cooling from the dwell temperature back to approximately room temperature;
(d) grinding the calcinated powder to form a second milled powder;
(e) shaping the second milled powder to form a plurality of shaped material portions; and
(f) sintering the plurality of shaped material portions.
